(19) United States
(12) Patent Application Publication
(10) Pub. No.: US 2003/0234929 A1
(43) Pub. Date: Dec. 25, 2003

(54) Method and system to reduce/detect a presence of gas in a flow of a cleaning fluid

(75) Inventors: Liang Kun Yueh, Hsin-Chu (TW); Jun Xiu Liu, Hsin-Chu (TW); Cheng Chieh Huang, Hsin-Chu (TW)

Correspondence Address: PATENT COUNSEL, APPLIED MATERIALS, INC., Legal Affairs Department, P.O. Box 450A, Santa Clara, CA, 95052, US

(73) Assignee: APPLIED MATERIALS, INC., Santa Clara, CA (US)

(21) Appl. No.: 10/179,663

(22) Filed: Jun. 24, 2002

(51) Int. Cl. G01N 21/00

(52) U.S. Cl. 356/338

(57) ABSTRACT

Provided are a method and an apparatus to reduce/detect a presence of a gas in fluids employed in semiconductor manufacturing processes. One embodiment of the invention includes creating a flow of cleaning fluids and impinging electromagnetic radiation upon a region of the flow. The electromagnetic radiation is sensitive to phase state changes in the flow, i.e., changes between liquid and gas, so that air bubbles in the liquid flow may be detected. The electromagnetic radiation is sensed and a signal is produced in response to phase state changes in the flow. The flow of the cleaning fluid is terminated in response to the signal. In accordance with another embodiment a system is provided that operates in accordance with the method.

The present invention relates to semiconductor manufacturing processes. More particularly, the present invention relates to a method and a system to reduce/detect a presence of gas in fluids employed in semiconductor manufacturing processes.

Formation of an integrated circuit requires multiple manufacturing steps and a variety of chemicals. To facilitate control of the chemical reactions, it is desired to remove chemical residue after certain manufacturing steps. To that end, cleaning fluids are employed.

One such cleaning fluid is deionized water. Deionized water is typically employed to clean residue produced by etching processes. Specifically, the deionized water, or deionized water vapor, is employed to remove chemical residue from a substrate.

Referring to FIG. 1, a conventional deionized water cleaning system 10 is employed in a metal-etch system 20. Cleaning system 10 includes a reservoir 12, a pump 16, and a filter 18. System 10 delivers deionized water to metal-etch system 20 by operation of pump 16. Pump 16 extracts deionized water from reservoir 12 and directs the same into metal-etch chamber 20 via flow passages 22 and 26. The operation of pump 16 often generates air bubbles in the flow of deionized water traversing flow passage 22.

The presence of air bubbles in the deionized water decreases the amount of water in a unit volume. This reduces the amount of water available to remove post-etch residue from a substrate. This leads to an insufficient passivation process that may cause severe metal corrosion of conductive traces on the substrate.

For example, aluminum is often employed to create conductive traces on substrates. Chlorine is a chemical often employed during etch processes and is left as a residue on the substrate. Failure to provide a sufficient amount of water to remove the chlorine residue may produce hydrochloric acid. Hydrochloric acid corrodes the aluminum conductive traces. This may lead to catastrophic failure of the integrated circuit being fabricated on the substrate.

To avoid the aforementioned problem, prior attempts have been made to remove air bubbles from the flow of deionized water. To that end, connected between pump 16 and metal-etch chamber 20 is filter 18, which traps and separates air from the flow of deionized water. The air then egresses from system 10 through a valve (not shown). A supply of deionized water is then released from outlet 26 to metal-etch chamber 20. Often, filter 18 is unable to trap and separate bubbles that generate as a result of filter replacement or during the reservoir 12.

Another prior art attempt to trap and separate air from a flow of deionized water is disclosed in U.S. Pat. No. 5,792,237 to Hung et al. Hung et al. disclose a method and an apparatus for eliminating trapped air from a liquid flow by utilizing a buffer tank and an electrical control box to supply a substantially air bubble-free liquid flow to semiconductor processing equipment. The method for eliminating trapped air from a liquid flow is carried out by first providing a liquid holding tank that has a top surface, a bottom surface and a generally cylindrical sidewall connecting the two surfaces. A first liquid inlet and a first liquid outlet are provided on the top surface. The first liquid inlet and first liquid outlet are placed in fluid communication with a cavity contained in the holding tank. A second liquid outlet is provided on or near a bottom surface of the tank. The second liquid outlet is placed in fluid communication with the cavity in the tank. A liquid is flowed into the first liquid inlet, and the cavity is filled substantially to the top. The liquid is flowed out of the first liquid outlet and into a liquid circulating means and re-enters the liquid flow into the first liquid inlet such that substantially all trapped air is accumulated at the upper portion of the liquid holding tank. A liquid that is substantially without trapped air is withdrawn from the second liquid outlet.

A need exists, however, to reduce/detect the presence of a gas in cleaning fluids that is less complicated than the prior art gas reduction/detection techniques.

### SUMMARY OF THE INVENTION

The present invention provides a method and a system to reduce/detect the presence of gas in fluids employed in semiconductor manufacturing processes. One embodiment of the invention includes creating the flow of the cleaning fluid and impinging electromagnetic radiation upon a region of the flow. The electromagnetic radiation is sensitive to phase state changes in the flow, i.e., changes between liquid and gas so that gas bubbles in the liquid flow may be detected. The electromagnetic radiation is sensed and a signal is produced in response to phase state changes in the flow. The flow of the cleaning fluid is terminated in response to the signal. In accordance with another embodiment a system is provided that operates in accordance with the method.

### BRIEF DESCRIPTION OF THE DRAWINGS

FIG. 1 is a simplified block diagram view showing a prior art deionized water cleaning system;

FIG. 2 is a simplified block diagram of an etch system employing one embodiment of the present invention;

FIG. 3 is a detailed plan view of a phase state change sensor shown in FIG. 2;

FIG. 4 is a graph of magnitude vs. time of a signal produced by a sensor shown in FIGS. 2 and 3;

FIG. 5 is a simplified block diagram of an etch system employing the present invention in accordance with an alternate embodiment; and

FIG. 6 is a detailed plan view of an alternate embodiment of the phase state change sensor shown in FIG. 3.

### DETAILED DESCRIPTION

Referring to FIG. 2, a processing system 30 in accordance with one embodiment of the present invention includes a processing chamber 32 for example, an etch chamber, and a gas panel 34 having supplies of process gases (not shown) and a vapor generator 36 and a processor 35 connected to control operation of processing system 30. Processing system 30 may be employed to perform any etch process known in the art. For purposes of the present discussion, processing system 30 is employed to etch metallization on substrate 37 disposed in processing chamber 32. As a result of the etch processes, residue remains on substrate 37.

Vapor generator 36 is employed to remove residue from substrate 37 by injecting a cleaning fluid into processing chamber 32. In one example, the cleaning fluid consists of deionized water vapor. To that end, vapor generator 36 is in fluid communication with processing chamber 32 and a supply of deionized water 40. A pump 42 is in fluid communication with supply 40 to create a flow of the deionized water that propagates from supply 40 to vapor generator 36 over conduit 44. Vapor generator 36 is in fluid communication with processing chamber 32 via conduit 38.

To remove residue from substrate 37 it is important to precisely control the amount of deionized water vapor injected into processing chamber 32. One problem, well known in the art, is the presence of gases, such as air, in a flow of deionized water vapor that presents as air bubbles. The presence of gases reduces an amount of deionized water vapor injected into processing chamber 32 at any moment in time. This can prevent removal of residue on substrate 37 and cause well known deleterious effects, e.g., corrosion of metallization on substrate 37.

To precisely regulate the amount of deionized water vapor injected into processing chamber 32, one embodiment of the present invention includes a phase state change sensor 46 coupled between vapor generator 36 and supply 40. Phase state change sensor 46 senses phase state changes in a flow of the cleaning fluid propagating through conduit 44. This enables detection of the presence of gas in the liquid cleaning fluid.

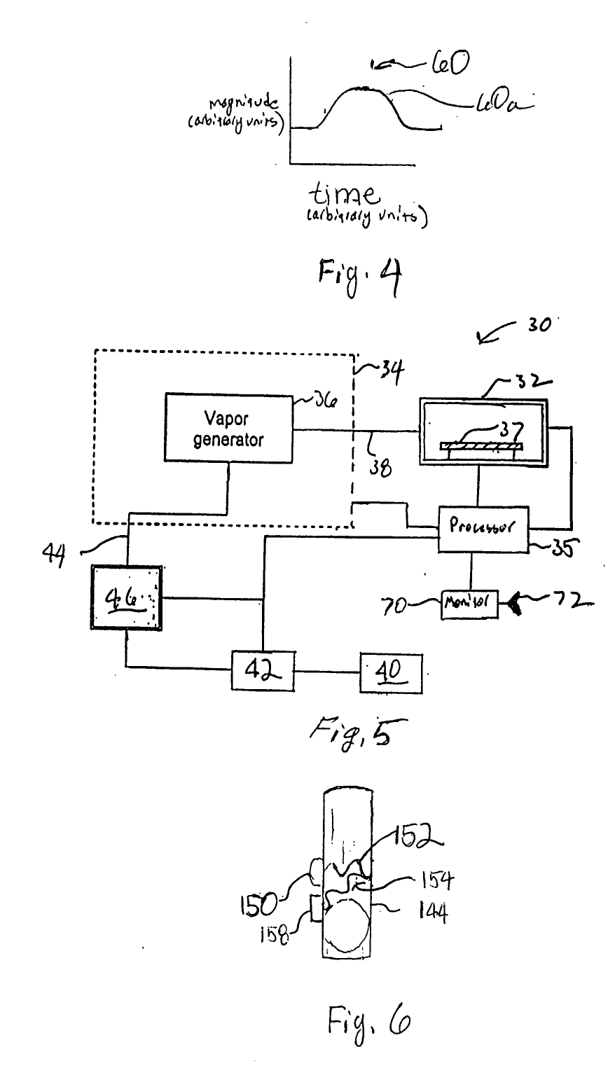

Referring to FIG. 3, phase state change sensor 46 includes a transmitter 50 to direct electromagnetic radiation 52 into a region 54 of conduit 44 through which a flow 56 of the cleaning fluid traverses. A receiver 58 is positioned to sense electromagnetic radiation 52 after impinging upon region 54. Electromagnetic radiation 52 is selected to propagate through conduit 44 and be responsive to a phase state change in region 54. In the present example, electromagnetic radiation 52 has a wavelength that is substantially shorter than the diameter of the conduit 44. In an alternate embodiment, the transmission is of an acoustic wave. Receiver 58 produces a signal 60 in response to the phase state change information contained in electromagnetic radiation 52, discussed more fully below with respect to FIG. 4.

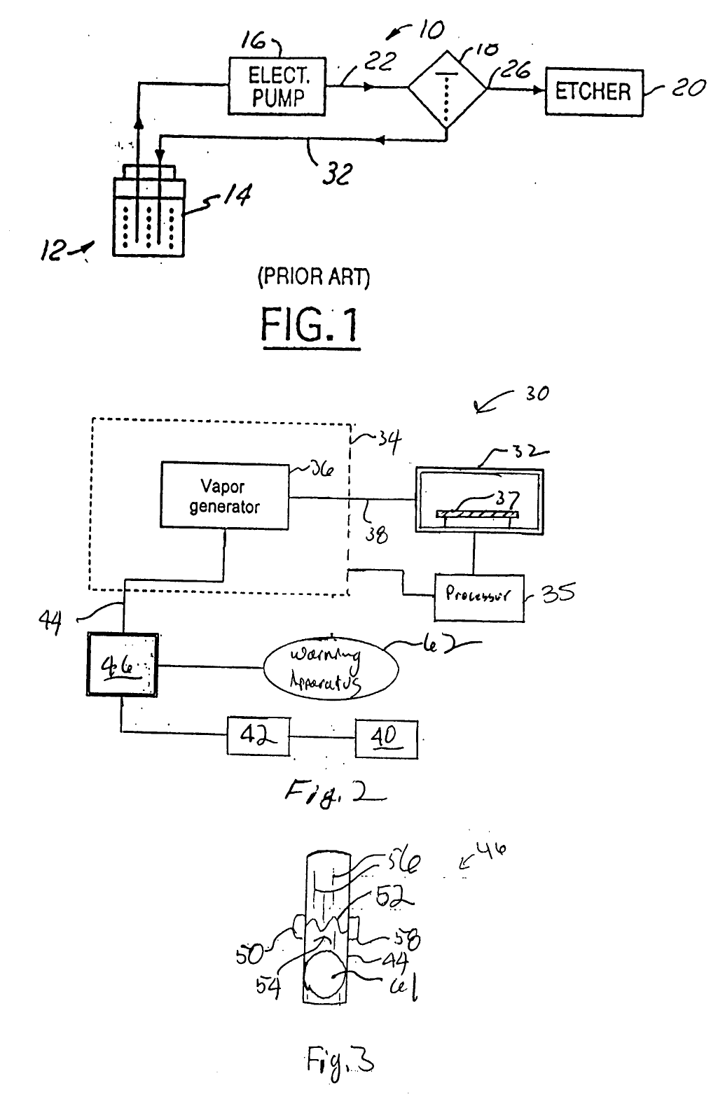

Referring to FIGS. 1, 2, 3 and 4, signal 60 contains information concerning the presence of a gas, such as air bubble 61, in flow 56 of liquid cleaning fluid. Signal 60 is transmitted to a warning apparatus 62, shown in FIG. 2, that is in electrical communication with phase state change sensor 46. Warning apparatus 62 may be any type known in the art that can provide a visual stimuli, audible stimuli or that is readily perceivable by an individual (not shown) processing system 30.

Referring to both FIGS. 2 and 3, the present invention facilitates terminating or modifying an etch process before water vapor, produced by vapor generator 36 from flow 56 containing air bubble 61, reaches processing chamber 32. Specifically, the flow of deionized water to vapor generator 36 would be terminated by, for example, deactivating pump 42. Air would be removed, bled, from conduit 44 and/or vapor generator 36 using known techniques. There after flow 56 could once again commence, free of air. This would prevent accumulation of air bubble 61 in vapor generator 36 facilitating regulation of the amount of moisture present in water vapor propagating along conduit 38 and into processing chamber 32. As a result, the aforementioned deleterious effects would be avoided.

Referring to FIGS. 3, 4 and 5, in an alternative embodiment, receiver 58 would be in electrical communication with processor 35. In this manner, processor 35 would operate on signal 60 and cease operation of pump 42 were phase state change information contained in signal 60. In addition, visual stimuli and/or audible stimuli could be generated on a monitor 70 and speaker 72, respectively, that are in electrical communication with processor 35.

In yet an alternative embodiment, processor 35 may be employed to analyze an amount of gas that propagates to vapor generator 36 over a period of time. As a result, termination of flow 56 could be dependent upon an amount of gas that is present in flow 56, measured during a period of time, as opposed to the occurrence of any amount of gas in flow 56. To that end, flow 56 may be terminated based upon signal 60 having predetermined characteristics indicative of the phase state change information contained therein. Alternatively the process may be modified to, for example, increase its duration so as to provide additional vapor.

With respect to FIGS. 3, 4 and 5, for example, processor 35 could operate on signal 60 and terminate flow 56 were signal 60 to have a predetermined magnitude. This predetermined magnitude would be selected to be indicative of an amount of gas that is in excess of a threshold quantity, above which deleterious effects to substrate 37 would occur. The exact quantity would vary depending upon several factors, such as the volume and rate of flow 56. As a result the exact quantity is dependent upon, inter alia, the size of conduit 44, the type of cleaning liquid, pumping rate of pump 42, as well as the chemistry employed during an etch process. Alternatively, processor 35 could terminate flow 56 were signal 60 to include, during a segment of time, a predetermined number of peaks 60a, or a plurality of peaks having a predetermined magnitude. In one example, processor 35 would terminate flow 56 by deactivating pump 42.

The embodiments of the present invention described above are exemplary, and it should be understood that several modifications may be made thereto while remaining within the scope of the invention. For example, as shown in FIG. 6, receiver 158 may be positioned to detect electromagnetic radiation, produced by transmitter 150, that is reflected from region 154, as opposed to sensing electromagnetic radiation 152 that propagates through conduit 144. The scope of the invention should not be determined with reference to the above description, but instead should be determined with reference to the appended claims along with their full scope of equivalents.

What is claimed is:

1. A method to reduce a presence of gas in a flow of a cleaning fluid introduced into a semiconductor process chamber, said method comprising:
creating said flow of said cleaning fluid;
impinging electromagnetic radiation upon a region of said flow, with said electromagnetic radiation being sensitive to phase state changes in said flow;
sensing said electromagnetic radiation and producing a signal in response phase state changes in said flow; and
terminating said flow of said cleaning fluid in response to said signal.

2. The method as recited in claim 1 wherein terminating said flow further includes terminating said flow of said cleaning fluid in response to said signal having a predetermined magnitude.

3. The method as recited in claim 1 wherein terminating said flow further includes terminating said flow of said cleaning fluid in response to said signal including a plurality of peaks having a predetermined magnitude.

4. The method as recited in claim 1 wherein terminating said flow further includes terminating said flow of said cleaning fluid in response to said signal having a plurality of peaks within a predetermined period of time.

5. The method as recited in claim 1 further including forming vaporized fluid by vaporizing said cleaning fluid after sensing said electromagnetic radiation, and creating a flow of said vaporized fluid into said semiconductor processing chamber.

6. The method as recited in claim 1 wherein impinging said electromagnetic radiation further includes reflecting said electromagnetic radiation from said region.

7. The method as recited in claim 1 wherein impinging said electromagnetic radiation further includes propagating said electromagnetic radiation through a cross-section of said flow.

8. The method as recited in claim 1 further including disposing a substrate within said semiconductor processing chamber and forming said vaporized fluid by vaporizing said cleaning fluid after sensing said electromagnetic radiation, and cleaning residue from said substrate.

9. The method as recited in claim 1 wherein terminating said flow further includes creating a perceivable stimuli in response to said signal, with said perceivable stimuli selected from a set of stimuli consisting of vibration, light and sound.

10. A method to detect a presence of gas in a flow of a cleaning fluid introduced into a semiconductor process chamber, said method comprising:
disposing a substrate within said processing chamber;
creating said flow of said cleaning fluid;
impinging electromagnetic radiation upon a region of said flow, with said electromagnetic radiation being sensitive to phase state changes in said flow;
sensing said electromagnetic radiation and producing a signal in response phase state changes in said flow; and
creating a flow of vaporized fluid into said processing chamber to remove residue from said substrate by vaporizing said cleaning fluid after sensing said electromagnetic radiation; and
terminating said flow of vaporized fluid into said processing chamber in response to said signal.

11. The method as recited in claim 10 wherein terminating said flow further includes terminating said flow of said cleaning fluid in response to said signal having a predetermined magnitude.

12. The method as recited in claim 10 wherein terminating said flow further includes terminating said flow of said cleaning fluid in response to said signal including a plurality of peaks having a predetermined magnitude.

13. The method as recited in claim 10 wherein terminating said flow further includes terminating said flow of said cleaning fluid in response to said signal having a predetermined number of peaks within a predetermined period of time.

14. The method as recited in claim 10 wherein terminating said flow further includes creating a perceivable stimuli in response to said signal, with said perceivable stimuli selected from a set of stimuli consisting of vibration, light and sound.

15. An etching system including:
an etch chamber;
a vaporizer in fluid communication with said etch chamber;
a supply of a cleaning liquid;
a conduit placing said supply in fluid communication with said vaporizer, with said supply adapted to direct a flow of said cleaning liquid through said conduit;
a transmitter to direct electromagnetic radiation into a region of said conduit, with said electromagnetic radiation being sensitive to phase state changes in said region; and
a receiver to sense said electromagnetic radiation after impinging upon said region to produce a signal in response to said electromagnetic radiation, with said signal including information concerning said phase state changes.

16. The system as recited in claim 15 wherein said receiver is disposed opposite to said transmitter to sense radiation propagating through said region.

17. The system as recited in claim 15 wherein said receiver is disposed to sense radiation reflecting from said region.

18. The system as recited in claim 15 further including a processor in electrical communication with both a detector and said supply, and a memory in electrical communication with said processor, said memory comprising a computer-readable medium having a computer-readable program embodied therein, said computer-readable program including a set of instructions to cause said processor to operate on said supply and terminate said flow of said cleaning fluid upon sensing said signal.

19. The system as recited in claim 18 wherein said set of instructions further includes a subroutine to cause said processor to operate on said supply to terminate said flow of said cleaning fluid in response to said signal having a predetermined magnitude.

20. The system as recited in claim 18 wherein said set of instructions further includes a subroutine to cause said processor to operate on said supply to terminate said flow of said cleaning fluid in response to said signal having a plurality of peaks having a predetermined magnitude.

21. The system as recited in claim 18 wherein said set of instructions further includes a subroutine to cause said processor to operate on said supply to terminate said flow of said cleaning fluid in response to said signal having a plurality of peaks within a predetermined period of time.
